(19) United States
(12) Patent Application Publication
(10) Pub. No.: US 2006/0197894 A1
(43) Pub. Date: Sep. 7, 2006

(54) Liquid crystal device and electronic apparatus

(75) Inventors: Masakatsu Higa, Chino-shi (JP); Masahiro Horiguchi, Matsumoto-shi (JP); Hayato Kurasawa, Matsumoto-shi (JP)

Correspondence Address: OLIFF & BERRIDGE, PLC, P.O. BOX 19928, ALEXANDRIA, VA, 22320, US

(73) Assignee: Sanyo Epson Imaging Devices Corp., Tokyo (JP)

(21) Appl. No.: 11/298,839

(22) Filed: Dec. 12, 2005

(30) Foreign Application Priority Data
Mar. 4, 2005 (JP) 2005-060024

(51) Int. Cl. G02F 1/1335

(52) U.S. Cl. 349/114

(57) ABSTRACT

A liquid crystal device includes a first substrate, a second substrate that is disposed to face the first substrate, a liquid crystal layer that is interposed between the first substrate and the second substrate, a plurality of first signal lines and a plurality of second signal lines that extend in directions intersecting each other in a surface of each of the substrates, and a plurality of pixels that are driven via pixel switching elements disposed to correspond to intersections of the plurality of first signal lines and the plurality of second signal lines. Each of the plurality of pixels has a transmissive display region that emits light incident from the second substrate to the first substrate, and reflective display regions that reflect light incident from the first substrate. The liquid crystal layer has liquid crystal having negative dielectric constant anisotropy. Each of the plurality of pixels has an alignment controller that controls alignment directions of liquid crystal molecules in the liquid crystal layer, and a liquid-crystal-layer thickness adjusting layer that makes the thickness of the liquid crystal layer in each reflective display region thinner than the thickness of the liquid crystal layer in the transmissive display region. In each of the plurality of pixels, the reflective display regions are disposed at least on both ends of an extension direction of the first signal lines.

### BACKGROUND

1. Technical Field

The present invention relates to a liquid crystal device which uses liquid crystal having negative dielectric constant anisotropy, and an electronic apparatus having such a liquid crystal device.

2. Related Art

In general, a liquid crystal device has a liquid crystal layer that is interposed between a first substrate disposed on a viewing surface side and a second substrate disposed on a side opposite to the viewing surface side, a plurality of first signal lines and a plurality of second signal lines that extend in directions intersecting each other in a surface of each of the substrates, and a plurality of pixels that are driven via pixel switching elements disposed to correspond to intersections of the plurality of first signal lines and the plurality of second signal lines. Further, among the liquid crystal devices, in a transflective liquid crystal device, in each of the plurality of pixels, a transmissive display region that emits light incident from the side opposite to the viewing surface side to the viewing surface side and a reflective display region that reflects light incident from the viewing surface side to the viewing surface side are formed.

In such a transflective liquid crystal device, if a reflecting layer is formed on the inner surface of the second substrate so as to constitute the reflective display region, reflective display cannot be performed only with one polarizing plate disposed on the viewing surface side. For this reason, a degree of freedom for optical design is low, and thus there is a problem in that a viewing angle narrows at the time of transmissive display.

As technologies for solving this problem, a VA (Vertical Alignment) mode in which liquid crystal having negative dielectric constant anisotropy is vertically aligned with respect to the substrate and liquid crystal molecules are inclined by the application of a voltage, or a multi-gap structure in which the thickness of the liquid crystal layer in the reflective display region is thinner than that in the transmissive display region so as to eliminate the difference of retardation (Δn·d) between transmissive display light and reflective display light is adopted. Further, a configuration for performing alignment division has been suggested in which the transmissive display region is an octagon, and a protrusion is provided at a center of a counter substrate as an alignment controller so as to make the liquid crystal molecules inclined in all directions. See, for example, Asia Display/IDW'01, p 133 (2001), Makoto Jisaki and Hidemasa Yamaguchi (hereinafter, referred to Non-Patent Document 1).

In a liquid crystal device using the VA mode, even when the alignment controller is provided in an image display region, a discontinuous line, which is called disclination, occurs in a peripheral portion of a pixel, an aperture ratio or contrast may be lowered. If the liquid crystal molecules are inclined in irregular directions, not controlled, a discontinuous line, which is called disclination, appears in a boundary between different liquid crystal alignment regions. Also, afterimages can be caused. Further, since the individual alignment regions of liquid crystal have different viewing angle characteristics, there is a problem in that spot-shaped stains may be perceived when the liquid crystal device is viewed from an oblique direction. In the configuration disclosed in Non-Patent Document 1, the control of the direction in which liquid crystal in the reflective display region is inclined is not considered. For this reason, in addition to alignment abnormality of liquid crystal in the reflective display region, alignment abnormality in its periphery is caused by the alignment abnormality, and thus transmissive display quality may be lowered.

Further, in a transflective liquid crystal device using the VA mode, if the multi-gap structure is adopted, alignment irregularity tends to occur at a step portion, and then contrast may be lowered due to optical leakage in an off state. Further, since the alignment irregularity tends to occur due to a traverse electric field between the pixels, the sufficient distance between the pixels needs to be ensured. If this structure is adopted, however, a pixel aperture ratio (the ratio of a portion directly contributing to display with respect to an entire pixel) may be lowered, and a sufficient amount of display light may be not ensured. In addition, in a liquid crystal device which uses a TFD (Thin Film Diode) element (a two-terminal-type nonlinear element) as a pixel switching element, counter electrodes are formed in stripe shapes as scanning electrodes (scanning lines), and thus an electric field generated between adjacent scanning electrodes may cause the alignment irregularity. For this reason, when the multi-gap structure is adopted, if the gap between the scanning electrodes is close to a step portion caused by a liquid-crystal-layer thickness adjusting layer, the alignment irregularity tends to occur, and thus contrast may be drastically lowered due to optical leakage in the off state.

### SUMMARY

An advantage of some aspects of the invention is that it provides a liquid crystal device which uses liquid crystal having negative dielectric constant anisotropy and, even when a difference of retardation in a transmissive display region and a reflective display region is eliminated by a liquid-crystal-layer thickness adjusting layer, can obtain favorable contrast characteristics, and an electronic apparatus.

According to an aspect of the invention, a liquid crystal device includes a first substrate, a second substrate that is disposed to face the first substrate, a liquid crystal layer that is interposed between the first substrate and the second substrate, a plurality of first signal lines and a plurality of second signal lines that extend in directions intersecting each other in a surface of each of the substrates, and a plurality of pixels that are driven via pixel switching elements disposed to correspond to intersections of the plurality of first signal lines and the plurality of second signal lines. Each of the plurality of pixels has a transmissive display region that emits light incident from the second substrate to the first substrate, and reflective display regions that reflect light incident from the first substrate. The liquid crystal layer has liquid crystal having negative dielectric constant anisotropy. Each of the plurality of pixels has an alignment controller that controls alignment directions of liquid crystal molecules in the liquid crystal layer, and a liquid-crystal-layer thickness adjusting layer that makes the thickness of the liquid crystal layer in each reflective display region thinner than the thickness of the liquid crystal layer in the transmissive display region. In each of the plurality of pixels, the reflective display regions are disposed at least on both ends of an extension direction of the first signal lines.

In the liquid crystal device according to the aspect of the invention, since liquid crystal having negative dielectric constant anisotropy is vertically aligned with respect to the surface of each of the substrates, a wide viewing angle at the time of transmissive display is obtained. Further, the thickness of the liquid crystal layer in the reflective display region is thinner than that in the transmissive display region, such that the difference of retardation (Δn·d) between transmissive display light and reflective display light is eliminated. Therefore, both transmissive display light and reflective display light can be suitably optical-modulated. In addition, since the alignment controllers are formed in the transmissive display region and the reflective display region so as to control the alignment directions of the liquid crystal molecules, the liquid crystal molecules are inclined in all directions in both the transmissive display region and the reflective display region. For this reason, alignment irregularity does not occur in any one of the transmissive display region and the reflective display region, and thus disclination does not occur. Further, since the reflective display regions are arrange on both ends of the extension direction of the first signal lines, the liquid-crystal-layer thickness adjusting layer is formed to be continuous between adjacent pixels in the extension direction of the first signal lines. Therefore, a step portion of the liquid-crystal-layer thickness adjusting layer is disposed at a boundary of adjacent pixels in the extension direction of the first signal lines, and thus, even when a traverse electric field between adjacent pixels in the extension direction of the first signal lines is generated at the time of the application of an off voltage, a place where the traverse electric field is generated and a place where the step portion is formed are separated from each other. Besides, in the reflective display region, the liquid crystal layer is thin, as compared with the transmissive display region, and thus an influence by the traverse electric field is difficult to be exerted. Further, in the reflective display region, there is little probability that both incident light and reflected light pass through places where alignment is irregular. Therefore, reflective display light is reliably optical-modulated by the liquid crystal layer and then is emitted. As a result, optical leakage in an off state due to the alignment irregularity in the vicinity of a boundary between adjacent pixels in the extension direction of the first signal lines can be prevented, and thus contrast can be enhanced.

In the liquid crystal device according to the aspect of the invention, the plurality of pixels may be driven in an inversion driving method in which signals having different polarities are applied to the liquid crystal layer between adjacent pixels in the extension direction of the first signal lines. A line inversion driving method is known as a driving method that is used to reduce a flicker or crosstalk. When the line inversion driving method is adopted, the traverse electric field is generated between adjacent pixels in the extension direction of the first signal lines. However, in the liquid crystal device according to the aspect of the invention, even when such a traverse electric field is generated, the place where the traverse electric field is generated and the step portion caused by the liquid-crystal-layer thickness adjusting layer are separated from each other, and the place where the traverse electric field is generated is the reflective display region. Therefore, even when the line inversion driving method is adopted, the alignment irregularity due to the traverse electric field can be prevented, optical leakage in the off state can be prevented, and contrast can be enhanced.

Further, when a tapered step portion of the liquid-crystal-layer thickness adjusting layer extends along a boundary of each reflective display region and the transmissive display region, the alignment irregularity tends to occur. However, in the liquid crystal device according to the aspect of the invention, since the place where the tapered step portion is formed is separated from the place where the traverse electric field is generated, the alignment irregularity due to the traverse electric field can be prevented, and contrast can be prevented from being degraded due to optical leakage in the off state.

In the liquid crystal device according to the aspect of the invention, it is preferable that the tapered step portion be disposed in each reflective display region. If the tapered step portion is formed in the reflective display region in which the thickness of the liquid crystal layer is thin, as compared with the transmissive display region, the alignment irregularity is difficult to generate. Further, in the reflective display region, there is little probability that both incident light and reflected light pass through the places where the alignment irregularity occurs. Therefore, optical leakage in the off state due to the alignment irregularity can be prevented, and contrast can be enhanced.

In the liquid crystal device according to the aspect of the invention, the alignment controller may have a protrusion formed at least one of an inner surface of the first substrate and an inner surface of the second substrate. Further, the alignment controller may have an opening formed in at least one of an electrode for driving liquid crystal formed on an inner surface of the first substrate and an electrode for driving liquid crystal formed on an inner surface of the second substrate.

In the liquid crystal device according to the aspect of the invention, each reflective display region may have a reflecting layer formed on the inner surface of the second substrate, and the transmissive display region may have a non-formation region of the reflecting layer.

In the liquid crystal device according to the aspect of the invention, it is preferable that each of the plurality of pixels be divided into a plurality of island-shaped subpixels, which are connected to one another via connecting portions having narrow widths, so as to correspond to the reflective display regions and the transmissive display region. Further, it is preferable that, in each of the plurality of pixels, subpixels be arranged at least on both ends of the extension direction of the first signal lines so as to correspond to the reflective display regions.

In the liquid crystal device according to the aspect of the invention, on one of the first substrate and the second substrate, a plurality of pixel electrodes may be formed so as to be electrically connected to the first signal lines via the pixel switching elements, which are two-terminal-type nonlinear elements, and, on the other substrate, the second signal lines may be formed as stripe electrodes. In this case, each pixel may be defined by an opposing portion of each stripe electrode and each pixel electrode. In such a configuration, for alignment division, at least one of the stripe electrode and the pixel electrode may be a portion corresponding to each pixel, and may be divided into a plurality of electrodes constituting the plurality of subpixels. In such a configuration, the stripe electrodes serving as the second signal lines are arranged in parallel by predetermined intervals. In this case, the traverse electric field is generated between adjacent first signal lines (strip shapes), but the step portion caused by the liquid-crystal-layer thickness adjusting layer is not close to places where the intervals are formed. Further, in any pixel, the reflective display region is close to such a place. Therefore, contrast can be prevented from being degraded due to optical leakage in the off state.

In the liquid crystal device according to the aspect of the invention, on one of the first substrate and the second substrate, a plurality of pixel electrodes may be formed so as to be electrically connected to the first signal lines via the pixel switching elements having thin film transistors formed at the intersections of the first signal lines and the second signal lines and, on the other substrate, a common electrode may be formed. Each pixel may be defined by an opposing portion of the common electrode and each pixel electrode. One of the common electrode and each pixel electrode may be a portion corresponding to each pixel, and may be divided into a plurality of electrodes constituting the plurality of subpixels.

In the liquid crystal device according to the aspect of the invention, on one substrate, an interlayer insulating film may be formed between the pixel switching elements and the pixel electrodes, and the pixel electrodes and the pixel switching elements may be electrically connected to each other via contact holes formed in the interlayer insulating film. In this case, it is preferable that the contact holes be correspondingly formed in the reflective display regions. Even when concavo-convexes occur due to the contact holes, if the concavo-convexes are within the reflective display region where the thickness of the liquid crystal layer is thin, the alignment irregularity is difficult to generate. Further, there is little probability that both incident light and reflected light pass through the places where the alignment irregularity occurs. Therefore, as compared with a case in which the contact hole is formed in the transmissive display region, optical leakage in the off state due to the concavo-convexes does not occur, and thus high contrast can be obtained.

The liquid crystal device according to the aspect of the invention can be used for an electronic apparatus, such as a cellular phone or a mobile computer.

### BRIEF DESCRIPTION OF THE DRAWINGS

The invention will be described with reference to the accompanying drawings, wherein like numbers reference like elements.

FIG. 1 is a block diagram showing an electrical configuration of a liquid crystal device according to a first embodiment of the invention.

FIG. 2A is a schematic perspective view of the liquid crystal device according to the first embodiment of the invention as obliquely viewed from below (counter substrate).

FIG. 2B is an explanatory view schematically showing a cross section of the liquid crystal device taken along a Y direction.

FIG. 3 is a diagram showing a waveform of a common signal when horizontal line inversion driving is performed.

FIG. 4 is a plan view schematically showing a pixel configuration for one dot of the liquid crystal device according to the first embodiment of the invention.

FIG. 5A is a cross-sectional view of one pixel of a plurality of pixels, which are formed in the liquid crystal device according to the first embodiment of the invention, on a magnified scale.

FIG. 5B is a cross-sectional view of a TFD in the liquid crystal device according to the first embodiment of the invention.

FIG. 6 is a cross-sectional view of one pixel of a plurality of pixels, which are formed in a liquid crystal device according to a modification of the first embodiment of the invention, on a magnified scale.

FIG. 7A is a cross-sectional view of one pixel of a plurality of pixels, which are formed in a liquid crystal device according to another modification of the first embodiment of the invention, on a magnified scale.

FIG. 7B is a cross-sectional view of a TFD in the liquid crystal device according to another modification of the first embodiment of the invention.

FIG. 8 is a block diagram showing an electrical configuration of a liquid crystal device according to a second embodiment of the invention.

FIG. 9 is a plan view schematically showing a pixel configuration for one dot of the liquid crystal device according to the second embodiment of the invention.

FIG. 10A is a cross-sectional view of one pixel of a plurality of pixels, which are formed in the liquid crystal device according to the second embodiment of the invention, on a magnified scale.

FIG. 10B is a cross-sectional view of a TFD in the liquid crystal device according to the second embodiment of the invention.

### DESCRIPTION OF EXEMPLARY EMBODIMENTS

Embodiments of the invention will be described with reference to the drawings. Moreover, in the following description, a substrate disposed on a viewing surface side is defined as a first substrate, and a substrate disposed on a side opposite to the viewing surface side is defined as a second substrate. In the respective drawings used for the following description, the scale of each layer or each member has been adjusted in order to have a recognizable size.

### First Embodiment

Overall Configuration

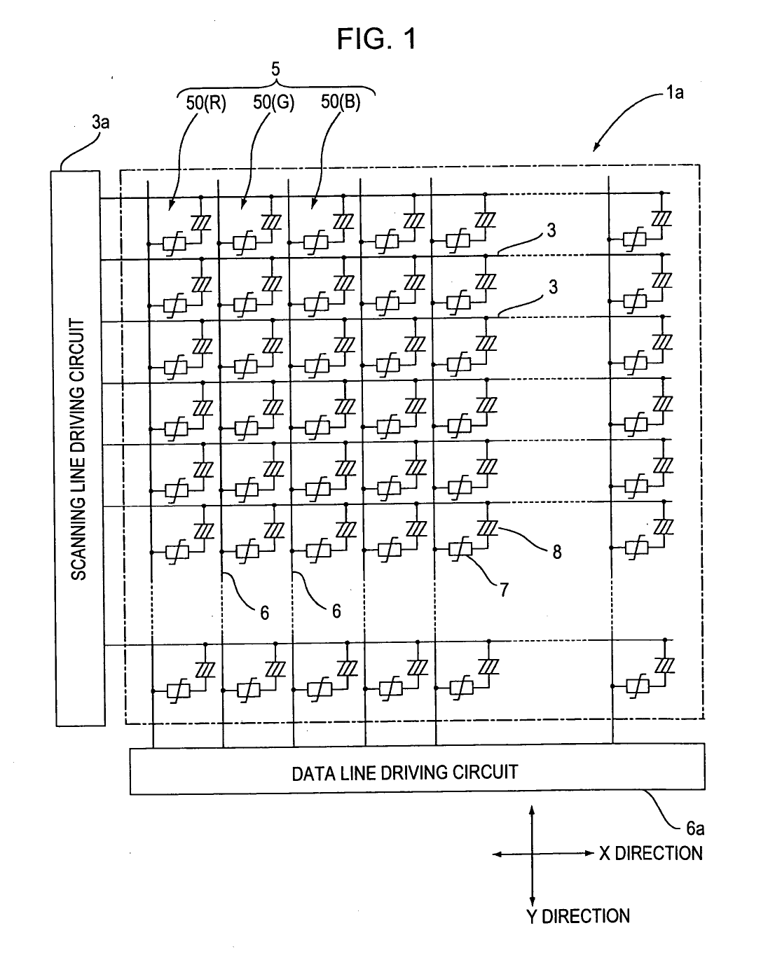

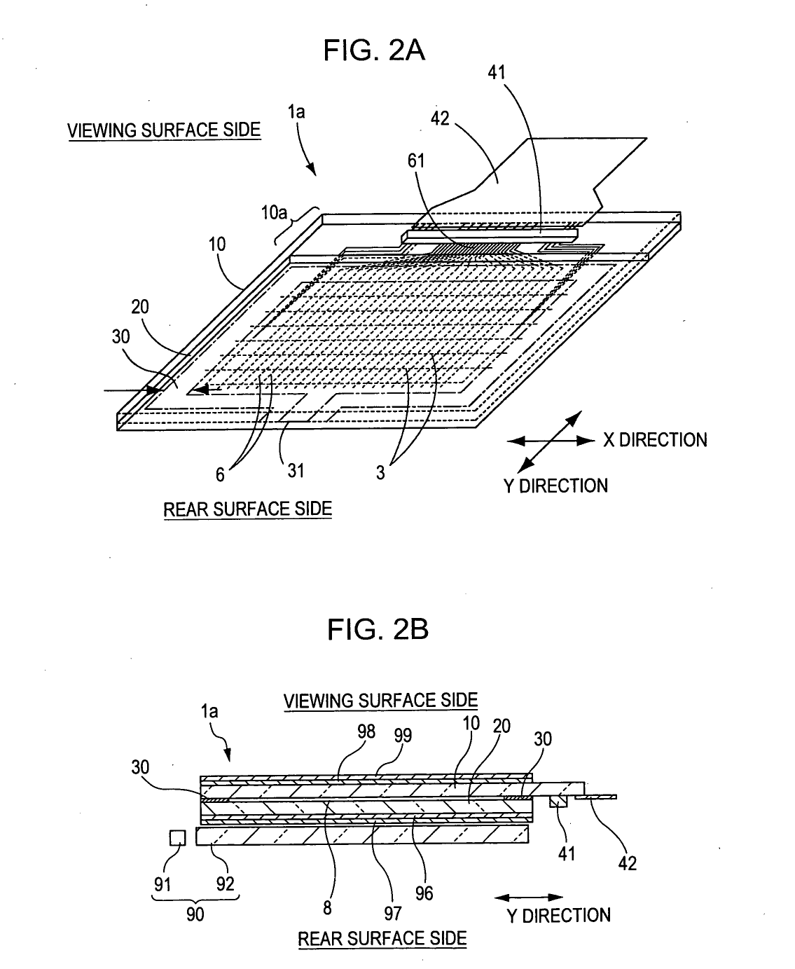

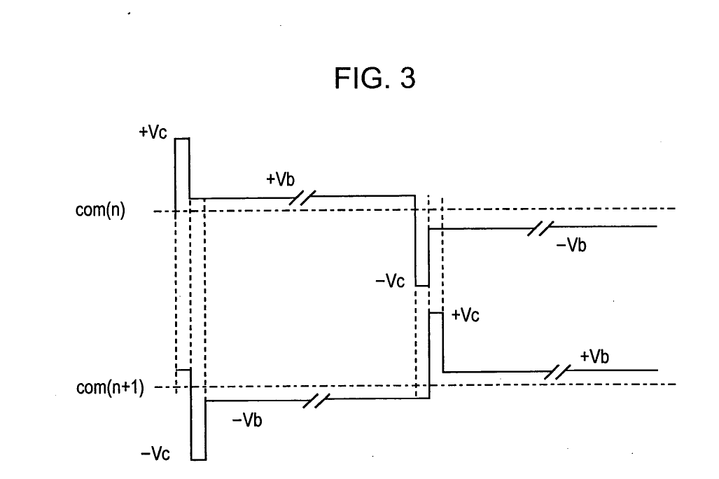

FIG. 1 is a block diagram showing the electrical configuration of a liquid crystal device according to a first embodiment of the invention. FIG. 2A is a schematic perspective view of the liquid crystal device according to the first embodiment of the invention as obliquely viewed from below (counter substrate). FIG. 2B is an explanatory view schematically showing a cross section of the liquid crystal device taken along a Y direction. FIG. 3 shows an example of a waveform of a common signal when horizontal line inversion driving is performed. Moreover, in the following description, for convenience, directions intersecting each other in the surface of each of the substrates are referred to as an X direction and a Y direction, respectively. Further, the side of an element substrate with respect to a liquid crystal layer is referred to as ‘viewing surface side’ to the effect that a viewer who views a display image is disposed. Further, in the present embodiment, the element substrate corresponds to the first substrate disposed on the viewing surface side, and a counter substrate corresponds to the second substrate disposed on the side opposite to the viewing surface side. In addition, in the present embodiment, since horizontal line inversion driving is performed, the polarity of a driving voltage is inverted between adjacent pixels in an extension direction of data lines (Y direction), and thus the data lines are referred to as first signal lines and scanning lines are referred to as second signal lines. In addition, since the liquid crystal device of the present embodiment is used for color display, pixels corresponding to red (R), green (G), and blue (B) are formed, and thus, for individual colors, symbols (R), (G), and (B) are correspondingly attached to the reference numerals.

A liquid crystal device 1a shown in FIG. 1 is a transflective active matrix-type liquid crystal device which uses a TFD (Thin Film Diode) as a switching element. When two directions intersecting each other are the X direction and the Y direction, respectively, a plurality of data lines 6 (first signal lines) extend in the Y direction (column direction), and a plurality of scanning lines 3 (second signal lines) extend in the X direction (row direction). At intersections of the scanning lines 3 and the data lines 6, pixels 50 (50(R), 50(G), and 50(B)) are correspondingly formed. In each pixel, a liquid crystal layer 8 and a pixel switching TFD 7 are connected in series. The individual scanning lines 3 are driven by a scanning line driving circuit 3a, and the individual data lines 6 are driven by a data line driving circuit 6a.

The plurality of pixels 50 correspond to red (R), green (G), and blue (B), respectively, according to colors of color filters described below. The pixels 50(R), 50(G), and 50(B) corresponding to the three colors function sub dots, respectively, and the three pixels 50(R), 50(G), and 50(B) constitute one dot 5. Therefore, in the present embodiment, a plurality of dots 5, each having the three pixels 50(R), 50(G), and 50(B), are arranged in a matrix shape.

As shown in FIGS. 2A and 2B, in order to constitute the liquid crystal device 1a, in the present embodiment, the element substrate 10 serving as the first substrate disposed on the viewing surface side and the counter substrate 20 serving as the second substrate disposed on the side opposite to the viewing surface side are bonded by a sealant 30, and then liquid crystal as an electro-optical material is filled in a region surrounded by both substrates and the sealant 30 so as to constitute the liquid crystal layer 8. The element substrate 10 and the counter substrate 20 are light-transmitting plate members, such as glass or quartz. The sealant 30 is substantially formed in a rectangular frame shape along the sides of the counter substrate 20, but a part thereof opens so as to fill liquid crystal. For this reason, after liquid crystal is filled, the opening is sealed by a sealing material 31.

The element substrate 10 has an extended region 10a which extends laterally from an edge of the counter substrate 20 in a state in which the element substrate 10 is bonded to the counter substrate 20 by the sealant 30. Wiring patterns extend toward the extended region 10a to be connected to the scanning line 3 and the data lines 6. In the sealant 30, plural conductive particles having conductivity are dispersed. For example, the conductive particles are plastic particles on which metal plating is performed or resin particles having conductivity. The conductive particles have a function of electrically connecting the wiring patterns formed on the element substrate 10 and the counter substrate 20 to each other. To this end, in the present embodiment, an IC 41 is mounted on the extended region 10a of the element substrate 10 so as to output signals to the scanning lines 3 and the data lines 6. Further, a flexible board 42 is connected to an edge of the extended region 10a of the element substrate 10.

As shown in FIG. 2B, in the liquid crystal device 1a of the present embodiment, a backlight device 9 is arranged on the side of the counter substrate 20 (rear surface side). The backlight device 9 has a light source 91 having a plurality of LEDs (light-emitting elements) or the like, and a light-guide plate 92, formed of transparent resin, in which light emitted from the light source 91 is incident from a side end surface thereof and is emitted from an emergent surface toward the counter substrate 20. Between the light-guide plate 92 and the counter substrate 20, a quarter-wave plate 96 and a polarizing plate 97 are arranged. Further, on the side of the element substrate 10, a quarter-wave plate 98 and a polarizing plate 99 are also arranged.

In the liquid crystal device 1a of the present embodiment having such a configuration, the horizontal line inversion driving method is adopted. As shown in FIG. 3, the polarity of a common signal (com) to be applied to the scanning lines 3 is inverted for each frame, and the common signal has different polarities between adjacent scanning lines 3 in the extension direction of the data lines 6 (Y direction). That is, a common signal com(n) to be applied to an n-th scanning line 3 and a common signal com(n+1) to be applied to an (n+1)-th scanning line 3 have different polarities. As for plurality of pixels 50 (50(R), 50(G), and 50(B)), a signal to be applied to the liquid crystal layer 8 has constantly different polarities between adjacent pixels in the extension direction of the data lines 6.

Basic Configuration of Pixel

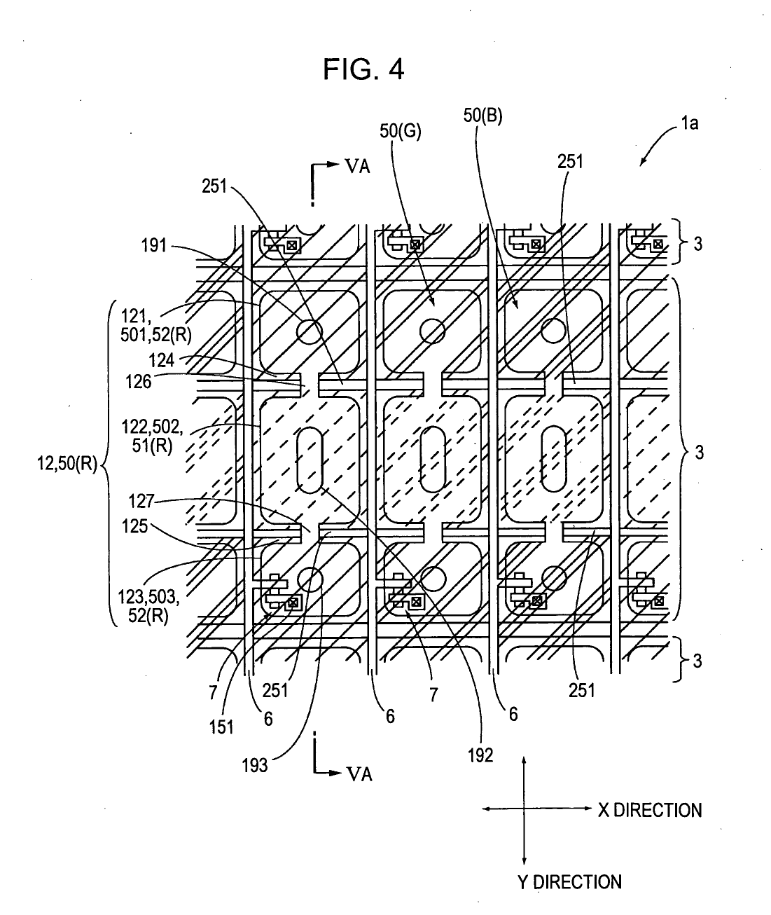

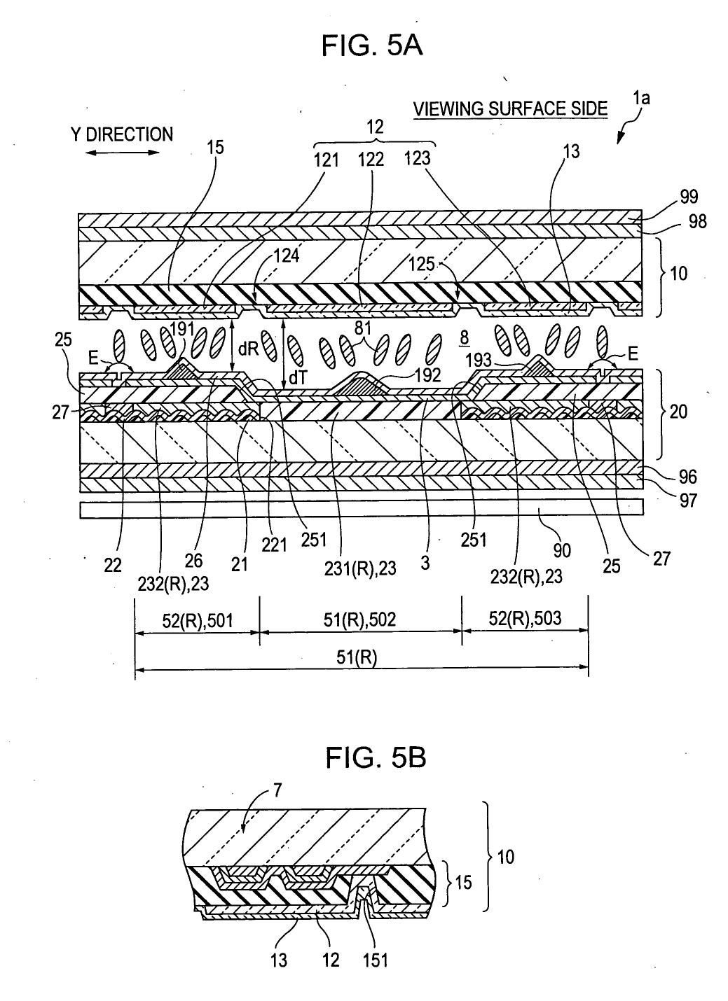

FIG. 4 is a plan view schematically showing the pixel configuration for one dot of the liquid crystal device according to the first embodiment of the invention. FIG. 5A is a cross-sectional view of one pixel (the pixel 50(R) corresponding to red (R)) of a plurality of pixels, which are formed in the liquid crystal device according to the first embodiment of the invention, on a magnified scale. FIG. 5B is a cross-sectional view of a TFD in the liquid crystal device according to the first embodiment of the invention. Moreover, in FIG. 4, the parts formed in the element substrate 10 and the parts formed in the counter substrate 20 are shown together without distinction, and oblique lines are appended to correspond to the kinds of color filters. Further, the pixels 50 (50(R), 50(G), and 50(B)) of the individual colors have a common basic structure, and, hereinafter, the pixel 50(R) corresponding to red (R) will be described preponderantly and the descriptions of the pixels 50(G) and 50(B) corresponding to other colors will be omitted.

As shown in FIGS. 4, 5A, and 5B, on the inner surface side of the element substrate 10 (the side of the liquid crystal layer 8), a transparent base film (not shown), the plurality of data lines 6, the TFDs 7 which are electrically connected to the data lines 6, an interlayer insulating film 15 formed of acrylic resin or the like, transparent pixel electrodes 12, formed of ITO (Indium Tin Oxide) or the like, which are electrically connected to the TFDs 7 via contact holes 151 formed in the interlayer insulating film 15, and a transparent alignment film 13 are formed. The pixel electrodes 12 are electrically connected to the data lines 6 via the TFDs 7. Each TFD 7 has two TFDs and is in an order of a first metal film, an oxidized film, and a second metal film as viewed from the data line 6 or as viewed from the opposite side thereof. For this reason, as compared with a case in which one diode is used, non-linear current-voltage characteristics are symmetrized over both positive and negative directions.

On the other hand, on the inner surface side of the counter substrate 20 (the side of the liquid crystal layer 8), a concavo-convex forming layer 21 formed of transparent photosensitive resin, a reflecting layer 22 formed of an aluminum alloy or a silver alloy, color filters 23, a liquid-crystal-layer thickness adjusting layer 25 formed of transparent photosensitive resin, stripe-shaped counter electrodes (scanning electrodes) serving as the scanning lines 3, and an alignment film 26 are formed. The scanning lines 3 are formed of ITO or the like. Here, the concavo-convex forming layer 21 has concavo-convexes formed on its surface. The concavo-convexes are reflected in the surface of the reflecting layer 22 as concavo-convexes for scattering.

Further, in any pixel 50(R), the concavo-convex forming layer 21 and the reflecting layer 22 are partially removed, and thus a light-transmitting portion 221 is formed in the reflecting layer 22. Accordingly, in the liquid crystal device 1a of the present embodiment, in any pixel 50(R), a reflective display region 52(R) is constituted by a region where the reflecting layer 22 is formed, and a transmissive display region 51(R) is constituted by a region where the reflecting layer 22 is removed (the light-transmitting portion 221). Therefore, the transmissive display region 51(R) emits light incident from the side opposite to the viewing surface side (light emitted from the backlight device 90) so as to perform color display in a transmissive mode. Further, the reflective display region 52(R) reflects external light incident from the viewing surface side to the viewing surface side so as to perform color display in a reflective mode. Moreover, since the concavo-convexes for scattering are formed on the surface of the reflecting layer 22, viewing angle dependency, such as different brightness according to an angle at which an image is viewed, or implanting of a background does not occur.

As the color filters 23, a color filter 231(R) for transmissive display is formed in the transmissive display region 51(R), and a color filter 232(R) for reflective display is formed in the reflective display region 52(R). As for the color filter 231(R) for transmissive display, the thickness, the kind of color material, or the compound amount is set in an optimum condition to display a color image in the transmissive mode. Further, as for the color filter 232(R) for reflective display, the thickness, the kind of color material, or the compound amount in an optimum condition to display a color image in the reflective mode. Therefore, light emitted from the reflective display region 52(R) to the viewing surface side passes through the color filter 232(R) for reflective display twice, while light emitted from the transmissive display region 51(R) to the viewing surface side passes through the color filter 231(R) for transmissive display once. In the liquid crystal device 1a of the present embodiment, for the transmissive mode and the reflective mode, excellent color reproducibility can be obtained, and a bright image can be displayed. Moreover, on the counter substrate 20, a light-shielding layer 27, which is called a black matrix or a black stripe, is formed to keep away from the regions facing the pixel electrodes 12. However, since the liquid crystal device of the invention is a normally black mode, the black matrix does not need to be used according to a degree of optical leakage.

Further, in the present embodiment, on the color filter 232(R) for reflective display, a liquid-crystal-layer thickness adjusting layer 25 formed of transparent photosensitive resin is formed. In the present embodiment, the liquid-crystal-layer thickness adjusting layer 25 is formed only in the reflective display region 52(R), not in the transmissive display region 51(R). Therefore, with the liquid-crystal-layer thickness adjusting layer 25, the thickness dR of the liquid crystal layer 8 in the reflective display region 52(R) is thinner than the thickness dT of the liquid crystal layer 8 in the transmissive display region 51(R). In this case, the thickness dR of the liquid crystal layer 8 in the reflective display region 52(R) is about half of the thickness dT of the liquid crystal layer 8 in the transmissive display region 51(R). For example, when the thickness dT of the liquid crystal layer 8 in the transmissive display region 51(R) is 4 μm, the liquid-crystal-layer thickness adjusting layer 25 having the thickness of 2 μm is formed. Therefore, light emitted from the reflective display region 52(R) to the viewing surface side passes through the liquid crystal layer 8 twice, while light emitted from the transmissive display region 51(R) to the viewing surface side passes through the liquid crystal layer 8 once. In the liquid crystal device 1a of the present embodiment, with the liquid-crystal-layer thickness adjusting layer 25, the thickness dR of the liquid crystal layer 8 in the reflective display region 52(R) is thinner than the thickness dT of the liquid crystal layer 8 in the transmissive display region 51(R). Accordingly, when refractive index anisotropy of liquid crystal is Δn (for example, 0.1), the difference of retardation (Δn·d) between transmissive display light and reflective display light can be eliminated. For this reason, both transmissive display light and reflective display light are suitably optical-modulated by the liquid crystal 8, and thus, in the transmissive mode and the reflective mode, a high-quality image can be displayed in view of contrast.

Alignment Division of Pixel

In the liquid crystal device 1a of the present embodiment having such a configuration, the liquid crystal layer 8 includes liquid crystal having negative dielectric constant anisotropy, and vertical alignment films are used as the alignment films 13 and 26. For this reason, in the liquid crystal layer 8, the liquid crystal molecules 81 are vertically aligned to the surface of each of the substrates in a state in which a voltage is not applied.

Further, each pixel electrode 12 is divided into three subpixel electrodes 121, 122, and 123 by slits 124 and 125 (notch), and one pixel 50(R) is divided into three subpixels 501, 502, and 503 in parallel along the extension direction of the data lines 6. Here, among the three subpixel electrodes 121, 122, and 123, only the subpixel electrode 123 is electrically connected to the TFD 7 via the contact hole 151 of the interlayer insulating film 15. The three subpixel electrodes 121, 122, and 123 are connected to one another via connecting portions 126 and 127 having narrow widths.

Here, on the counter substrate 20, the reflecting layer 22, the color filter 232(R) for reflective display, and the liquid-crystal-layer thickness adjusting layer 25 are formed in regions corresponding to the subpixels 501 and 503 at both ends (regions corresponding to the subpixel electrodes 121 and 123), excluding a region corresponding to the subpixel 502 at the center (a region corresponding to the subpixel electrode 122). Accordingly, in the present embodiment, in each pixel 50(R), the central region of the extension direction of the data lines 6 (Y direction) is the transmissive display region 51(R), and the regions at both ends of the extension direction of the data lines 6 are the reflective display regions 52(R). For this reason, the liquid-crystal-layer thickness adjusting layer 25 is formed in a boundary region of adjacent pixels in the extension direction of the data lines 6, and is continuously formed in adjacent pixels in the extension direction of the data lines 6. And then, an end of the liquid-crystal-layer thickness adjusting layer 25 constitutes a step portion 251 having a taper inclined upward in a boundary region of the reflective display region 52(R) and the transmissive display region 51(R) and, at the step portion 251, the liquid crystal molecules 81 have a pretilt with respect to the surface of each of the substrates. In the present embodiment, the step portion 251 is disposed to be separated from the boundary region between adjacent pixels in the extension direction of the data lines 6. Besides, as shown in FIG. 5A, the step portion 251 of the liquid-crystal-layer thickness adjusting layer 25 is disposed inside the reflective display region 52(R).

In addition, at positions facing the centers of the three subpixel electrodes 121, 122, and 123 of the counter substrate 20, alignment control protrusions 191, 192, and 193 (alignment controllers), which protrude toward the element substrate 10, are formed below the alignment film 26. Accordingly, in the present embodiment, the alignment control protrusions 191, 192, and 193 are correspondingly formed in the three subpixels 501, 502, and 503. The alignment control protrusions 191, 192, and 193 are conical shapes each having the height of 1.2 μm and the diameter of a bottom surface of 12 μm, and constitute a gentle inclined surface having a pretilt in an interface of the alignment film 26. The alignment control protrusions 191, 192, and 193 can be formed by developing a novolac-based positive photoresist and post-baking.

Main Effects of Present Embodiment

As described above, in the liquid crystal device 1a of the present embodiment, the liquid crystal molecules 81 having negative dielectric constant anisotropy are vertically aligned with respect to the surface of each of the substrates, and are inclined by the application of a voltage, such that optical modulation is performed. As a result, optical leakage at the time of black display can be reduced, and high display contrast can be obtained.

Further, the alignment control protrusions 191, 192, and 193 are formed in the transmissive display region 51 and the reflective display region 52 so as to control the alignment directions of the liquid crystal molecules 81. Therefore, in both the transmissive display region 51 and the reflective display region 52, the liquid crystal molecules are inclined in all directions. For this reason, in any one of the transmissive display region 51 and the reflective display region 52, the alignment irregularity does not occur. As a result, disclination does not occur, and thus display can be performed with a wide viewing angle with no afterimages or spot-shaped stains.

In addition, with the liquid-crystal-layer thickness adjusting layer 25, the thickness of the liquid crystal layer 8 in the reflective display region 52 is thinner than that in the transmissive display region 51, such that the difference of retardation (Δn·d) between transmissive display light and reflective display light is eliminated. As a result, transmissive display light and reflective display light can be suitably optical-modulated.

In addition, in any pixel 50, the reflective display regions 52 are arranged at both ends of the extension direction of the data lines 6 (Y direction), and thus the liquid-crystal-layer thickness adjusting layer 25 is continuously formed between adjacent pixels in the extension direction of the data lines 6. When the line inversion driving method is adopted in which the signals to be applied to the liquid crystal layer 8 between adjacent pixels in the extension direction of the data lines 6 have different polarities, as shown in an arrow E of FIG. 5A, the traverse electric field is generated between adjacent scanning lines 3 even when the off voltage is applied. In the present embodiment, however, since the step portion 251 of the liquid-crystal-layer thickness adjusting layer 25 is not disposed in the boundary region of adjacent pixels in the extension direction of the data lines 6, and the place where the traverse electric field is generated is separated from the place where the step portion 251 is formed, little alignment irregularity occurs in the liquid crystal molecules 81. That is, though the liquid crystal molecules 81 have the pretilt with respect to the surface of each of the substrates at the step portion 251, there is no case in which the liquid crystal molecules 81 with the pretilt are significantly inclined by the traverse electric field at the time of the application of the off voltage.

Besides, when the off voltage is applied, the place where the traverse electric field indicated by the arrow E is generated is in the reflective display region 52. In the reflective display region 52, the liquid crystal layer 8 is thin, as compared with the transmissive display region 51, and thus an influence by the traverse electric field is not exerted. In addition, the place where the step portion 251 of the liquid-crystal-layer thickness adjusting layer 25 is disposed is in the reflective display region 52, and thus optical leakage in the transmissive display region is not caused. Further, in the reflective display region 52, there is little probability that incident light and reflected light pass through the places where the alignment irregularity occurs, and thus light is subjected to optical modulation by the liquid crystal layer 8 at the time of incidence or at the time of reflection. For this reason, according to the present embodiment, optical leakage in the off state due to the alignment irregularity in the vicinity of the boundary region between adjacent pixels in the extension direction of the data lines 6 or the alignment irregularity in the vicinity of the step portion 251 of the liquid-crystal-layer thickness adjusting layer 25 can be prevented. As a result, in both transmissive display and reflective display, contrast can be enhanced.

Further, in the present embodiment, among the three subpixel electrodes 121, 122, and 123, only the subpixel electrode 123 is electrically connected to the TFD 7 via the contact hole 151 of the interlayer insulating film 15, and the contact hole 151 is formed at the position overlapping the subpixel electrode 123 in plan view, that is, in the reflective display region 52. Therefore, even when the concavo-convex due to the contact hole 151 occurs, since the liquid crystal layer 8 in the reflective display region 52 is thin and, in the reflective display region 52, there is little probability that incident light and reflected light pass through the places where the alignment irregularity occurs, optical leakage in the off state due to the concavo-convex is difficult to generate, as compared with a case in which the contact hole 151 is formed in the transmissive display region 51. For this reason, according to the present embodiment, high contrast can be obtained.

For this reason, the comparison result of the liquid crystal device 1a of the present embodiment and the liquid crystal device described in Non-Patent Document 1 (Related Art) is as follows.

| | BRIGHTNESS | BRIGHTNESS | |
|---|---|---|---|
| | IN | IN | |
| | ON STATE | OFF STATE | CONTRAST |
| LIQUID CRYSTAL | 194.3 cd/m² | 0.61 cd/m² | 319 |
| DEVICE 1a OF | | | |
| PRESENT | | | |
| EMBODIMENT | | | |
| LIQUID CRYSTAL | 193.1 cd/m² | 1.02 cd/m² | 189 |
| DEVICE OF | | | |
| RELATED ART | | | |

According to the liquid crystal device 1a of the present embodiment, contrast corresponding to two times as much as that in the related art can be obtained.

Moreover, the step portion 251 of the liquid-crystal-layer thickness adjusting layer 25 is disposed in the boundary region of adjacent pixels in the extension direction of the scanning lines 3 (X direction). However, in this direction, the polarities of the driving voltage between adjacent pixels are the same, and thus the influence by the traverse electric field is not exerted.

### Modification of First Embodiment

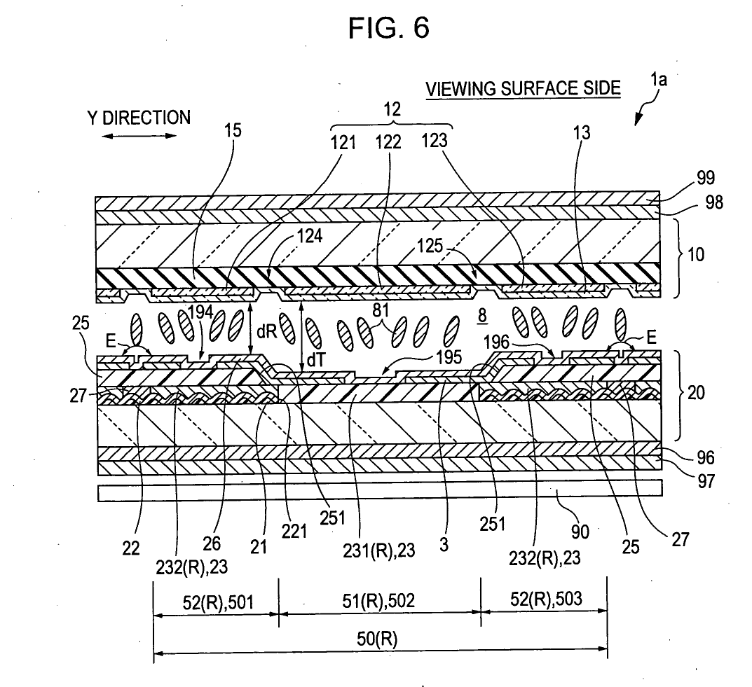

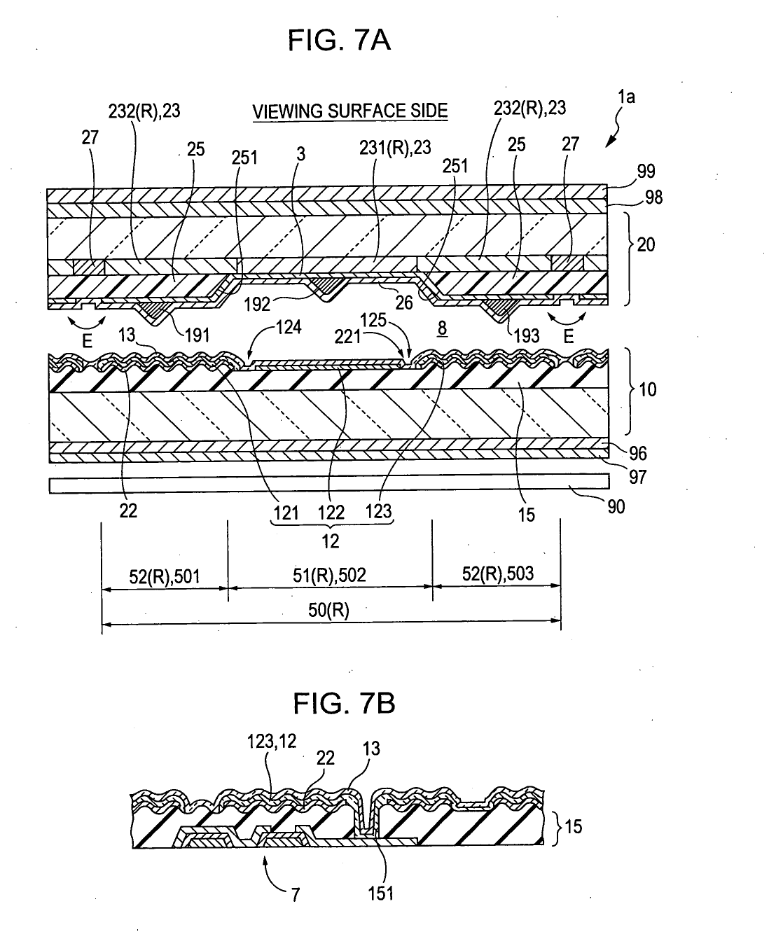

FIG. 6 is a cross-sectional view of one pixel (the pixel 50(R) corresponding to red (R)) of a plurality of pixels, which are formed in a liquid crystal device according to a modification of the first embodiment of the invention, on a magnified scale. FIG. 7A is a cross-sectional view of one pixel (the pixel 50(R) corresponding to red (R)) of a plurality of pixels, which are formed in a liquid crystal device according to another modification of the first embodiment of the invention, on a magnified scale. FIG. 7B is a cross-sectional view of a TFD in the liquid crystal device according to another modification of the first embodiment of the invention. Moreover, the basic configuration of the present embodiment is the same as that in the first embodiment, the same parts are represented by the same reference numerals, and the descriptions thereof will be omitted.

In the liquid crystal device 1a of the above-described embodiment, as the alignment controllers that control the alignment directions of the liquid crystal molecules 81 in the transmissive display region 51 and the reflective display region 52, the alignment control protrusions 191, 192, and 193 are formed. On the other hand, in the present embodiment, as shown in FIG. 6, the liquid crystal molecules 81 having negative dielectric constant anisotropy are vertically aligned with respect to the surface of each of the substrates. Further, in order to provide the alignment controllers for the transmissive display region 51 and the reflective display region 52, alignment control slits 194, 195, and 196 (openings) are correspondingly formed in the subpixel electrodes 121, 122, and 123. For this reason, in the transmissive display region 51 and the reflective display region 52, the liquid crystal molecules are inclined in all directions. Therefore, in any one of the transmissive display region 51 and the reflective display region 52, the alignment irregularity does not occur, and thus disclination does not occur. Other parts are the same as those in the first embodiment.

The comparison result of the liquid crystal device 1a having such a configuration and the liquid crystal device described in Non-Patent Document 1 (Related Art) is as follows.

| | BRIGHTNESS | BRIGHTNESS | |
|---|---|---|---|
| | IN | IN | |
| | ON STATE | OFF STATE | CONTRAST |
| LIQUID CRYSTAL | 191.7 cd/m² | 0.54 cd/m² | 355 |
| DEVICE 1a OF | | | |
| PRESENT | | | |
| EMBODIMENT | | | |
| LIQUID CRYSTAL | 193.1 cd/m² | 1.02 cd/m² | 189 |
| DEVICE OF | | | |
| RELATED ART | | | |

As apparent from the table, contrast corresponding to two times as much as that in the related art can be obtained.

Further, in the present embodiment, for the transmissive display region 51 and the reflective display region 52, in order to provide the alignment controllers that control the alignment directions of the liquid crystal molecules 81, the alignment control slits 194, 195, and 196 (openings) are correspondingly formed in the subpixel electrodes 121, 122, and 123. Therefore, when the individual subpixel electrodes 121, 122, and 123 are formed by patterning, the alignment control slits 194, 195, and 196 (openings) can be simultaneously formed. For this reason, the number of manufacturing processes can be reduced.

Moreover, the alignment controllers may be formed in the pixel electrodes 12 or the scanning lines 3 (scanning electrodes). Further, the color filter 23 or the liquid-crystal-layer thickness adjusting layer 25 may be formed on one of the element substrate 10 and the counter substrate 20.

For example, as shown in FIGS. 7A and 7B, when the counter substrate 20 is disposed on the viewing surface side as the first substrate, and the element substrate 10 is disposed on the side opposite to the viewing surface side as the second substrate, the interlayer insulating film 15 of the element substrate 10 may be formed as the concavo-convex forming layer having the concavo-convexes formed on its surface, and then the reflecting layer 22 having the light-transmitting portion 221 may be formed on the interlayer insulating film 15. In this case, the color filter 23 or the liquid-crystal-layer thickness adjusting layer 25 may be formed on one of the inner surface of the counter substrate 20 and the inner surface of the element substrate 10. FIG. 7A shows an example in which the color filter 23 or the liquid-crystal-layer thickness adjusting layer 25 is formed on the inner surface of the counter substrate 20.

In this configuration, the liquid crystal molecules having negative dielectric constant anisotropy are vertically aligned with respect to the surface of each of the substrates, and the liquid crystal molecules are inclined by the application of the voltage, such that optical modulation is performed. Therefore, in the transflective liquid crystal device 1a, a wide viewing angle is realized at the time of transmissive display. Further, with the liquid-crystal-layer thickness adjusting layer 25, the thickness of the liquid crystal layer 8 in the reflective display region 52 is thinner than that in the transmissive display region 51, and the difference of retardation (Δn·d) between transmissive display light and reflective display light is eliminated. Therefore, transmissive display light and reflective display light can be suitably optical-modulated.

In addition, in any pixel 50, like the first embodiment, the reflective display regions 52 are arranged at both ends of the extension direction of the data lines 6 (Y direction), and thus the liquid-crystal-layer thickness adjusting layer 25 is continuously formed between adjacent pixels in the extension direction of the data lines 6. When the line inversion driving method is adopted in which the signals to be applied to the liquid crystal layer 8 between adjacent pixels in the extension direction of the data lines 6 have different polarities, as shown in an arrow E of FIG. 7A, the traverse electric field is generated between adjacent scanning lines 3 even when the off voltage is applied. In the present embodiment, however, since the step portion 251 of the liquid-crystal-layer thickness adjusting layer 25 is not disposed in the boundary region of adjacent pixels in the extension direction of the data lines 6, and the place where the traverse electric field is generated is separated from the place where the step portion 251 is formed, little alignment irregularity occurs in the liquid crystal molecules. That is, though the liquid crystal molecules 81 have the pretilt with respect to the surface of each of the substrates at the step portion 251, there is no case in which the liquid crystal molecules 81 with the pretilt are significantly inclined by the traverse electric field at the time of the application of the off voltage. Besides, when the off voltage is applied, the place where the traverse electric field indicated by the arrow E is generated is in the reflective display region 52. In the reflective display region 52, the liquid crystal layer 8 is thin, as compared with the transmissive display region 51, and thus an influence by the traverse electric field is not exerted. Further, in the reflective display region 52, there is little probability that incident light and reflected light pass through the places where the alignment irregularity occurs, and thus light is subjected to optical modulation by the liquid crystal layer 8 at the time of incidence or at the time of reflection. For this reason, according to the present embodiment, optical leakage in the off state due to the alignment irregularity in the vicinity of the boundary region between adjacent pixels in the extension direction of the data lines 6 can be prevented. As a result, contrast can be enhanced.

Moreover, in the present embodiment, the stripe electrodes formed on the counter substrate 20 serve as the scanning lines 3, and the signal lines formed on the element substrate serve as the data lines. However, the stripe electrodes formed on the counter substrate 20 may serve as the data lines, and the signal lines formed on the element substrate may serve as the scanning lines.

### Second Embodiment

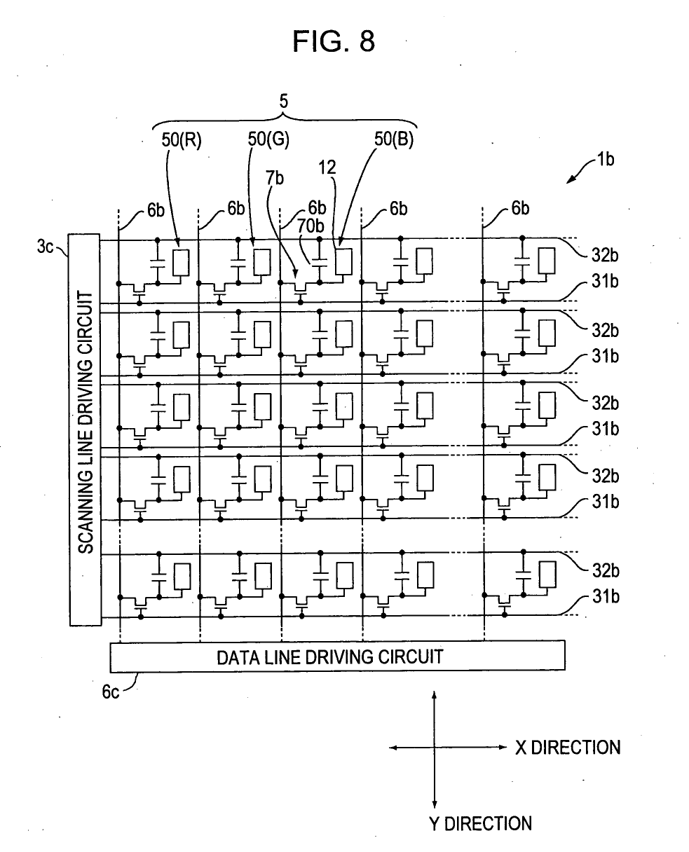

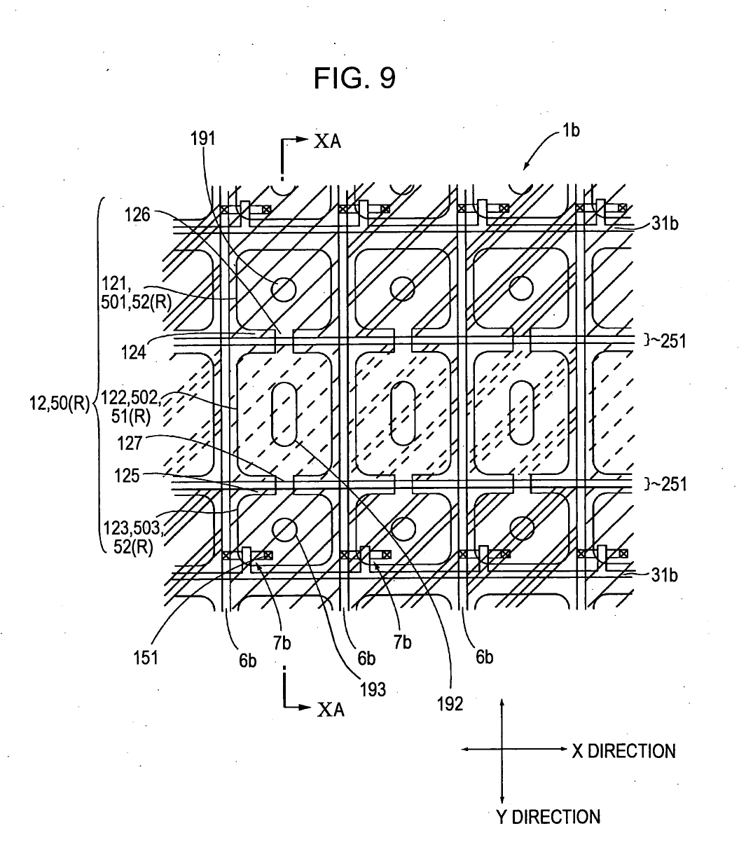

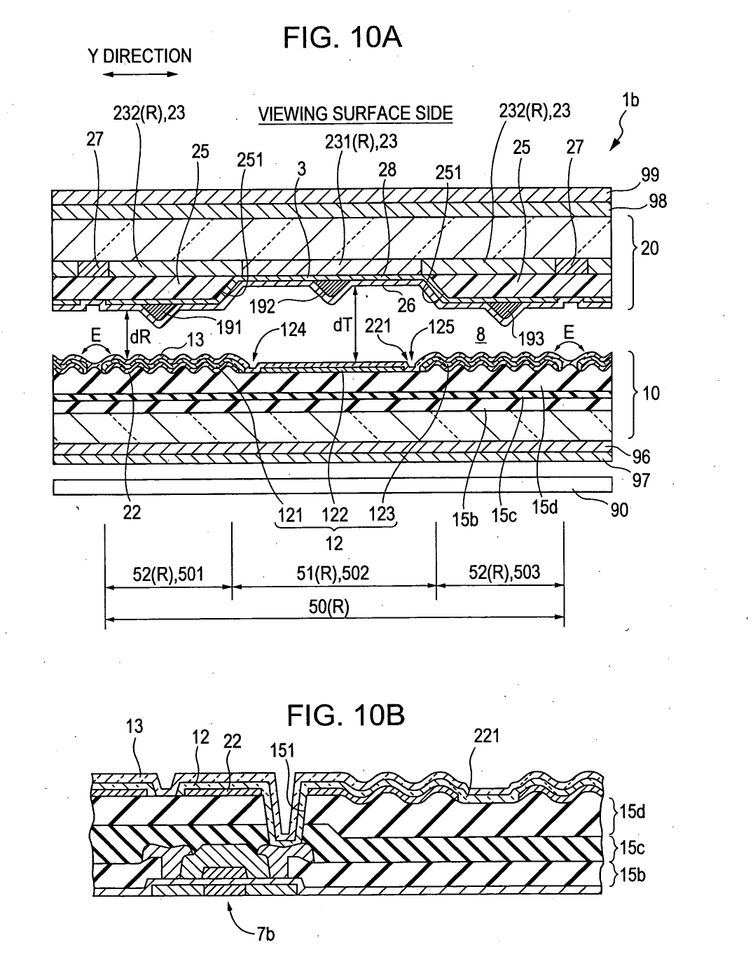

FIG. 8 is a block diagram showing the electrical configuration of a liquid crystal device according to a second embodiment of the invention. FIG. 9 is a plan view schematically showing a pixel configuration for one dot of the liquid crystal device according to the second embodiment of the invention. FIG. 10A is a cross-sectional view of one pixel of a plurality of pixels, which are formed in the liquid crystal device according to the second embodiment of the invention, on a magnified scale. FIG. 10B is a cross-sectional view of a TFD in the liquid crystal device according to the second embodiment of the invention. Moreover, in the following description, for convenience, directions intersecting each other in the surface of each of the substrates are also referred to as an X direction and a Y direction, respectively. Further, the side of an element substrate with respect to a liquid crystal layer is referred to as ‘viewing surface side’ to the effect that a viewer who views a display image is disposed. Further, in the present embodiment, a counter substrate corresponds to the first substrate disposed on the viewing surface side, and the element substrate corresponds to the second substrate disposed on the side opposite to the viewing surface side. Further, since the liquid crystal device of the present embodiment is used for color display, pixels corresponding to red (R), green (G), and blue (B) are formed, and thus, for individual colors, symbols (R), (G), and (B) are correspondingly attached to the reference numerals. Moreover, for ease of understanding on the correspondence to the first embodiment, the parts having the same function are represented by the same reference numerals, and the descriptions thereof will be omitted.

A liquid crystal device 1b shown in FIG. 8 is a transflective active matrix-type liquid crystal device which uses a TFT (Thin Film Transistor) as a switching element. In the liquid crystal device 1b, a plurality of scanning lines 31b are formed in the X direction (row direction) and a plurality of data lines 6b are formed in the Y direction (column direction). At positions corresponding to intersections of the scanning lines 31b and the data lines 6b, pixels 50 are formed and, in each pixel 50, a pixel switching TFT 7b (non-linear element) is provided. The individual scanning lines 31b are driven by a scanning line driving circuit 3c, and the individual data lines 6b are driven by a data line driving circuit 6c. The data line 6b is electrically connected to a source of the TFT 7b and the scanning line 31b is electrically connected to a gate of the TFT 7b. To the scanning lines 31b, scanning signals are supplied from the scanning line driving circuit 3c in a pulsed manner with predetermined timing. A pixel electrode 12b is electrically connected to a drain of the TFT 7b. When the TFT 7b is in an on state for a constant period, a pixel signal supplied from the data line 6b is written into each pixel with predetermined timing. In such a manner, the pixel signal having a predetermined level written into a liquid crystal layer via the pixel electrode 12b is held between the pixel electrode and a counter electrode formed on a counter substrate described below for a constant period. Here, in order to prevent leakage of the held pixel signal, with a capacitor line 32b, a storage capacitor 70b (capacitor) may be added in parallel with a liquid crystal capacitor formed between the pixel electrode 12b and the counter electrode. For example, the voltage of the pixel electrode 12b is held by the storage capacitor 70b for a longer time, namely, for a period as much as three orders of magnitude longer than the time for which a source voltage is applied. Accordingly, a liquid crystal device, which has an improved electric charge holding property and can perform display with a high contrast ratio, can be implemented.

In the liquid crystal device 1b of the present embodiment, a plurality of pixels 50 correspond to red (R), green (G), and blue (B) according to colors of color filters described below. The pixels 50(R), 50(G), and 50(B) corresponding to the three colors function sub dots, and the pixels 50 for the three colors constitute one dot 5.

In the liquid crystal device 1b having such a configuration, when the horizontal line inversion driving method is adopted, the signals applied to the liquid crystal layer between adjacent pixels in the extension direction of the data lines 6b constantly have different polarities, and thus the traverse electric field is generated. Further, when a vertical line inversion driving method is adopted, the signals applied to the liquid crystal layer between adjacent pixels in the extension direction of the scanning lines 31b constantly have different polarities, and thus the traverse electric field is generated. Further, when the difference in voltage applied to the pixel electrode 12b is significant, the traverse electric field is generated. In the following description, the configuration for preventing the influence by the traverse electric field generated between adjacent pixels in the extension direction of the data lines 6b will be described. Therefore, in the following description, the data lines 6b correspond to the first signal lines, and the scanning lines 31b correspond to the second signal lines.

When the liquid crystal device 1b of the present embodiment is a transflective type, as shown in FIGS. 9, 10A, and 10B, on the transparent substrate 10, the TFTs 7b, transparent interlayer insulating films 15b and 15c formed of silicon nitride thin film or the like, an interlayer insulating film 15d (concavo-convex forming layer), formed of transparent photosensitive resin, which has concavo-convexes formed on its surface, a reflecting layer 22 formed of an aluminum alloy or a silver alloy, the pixel electrodes 12 formed of ITO or the like, and an alignment film 13 are sequentially formed. In the reflecting layer 22, the light-transmitting portion 221 is formed by a notched portion. In contrast, on the transparent counter substrate 20, color filters 23, a liquid-crystal-layer thickness adjusting layer 25 formed of transparent photosensitive resin, a counter electrode 28 (common electrode) formed of ITO or the like, and an alignment film 26 are sequentially formed. Here, as the color filters 23, a color filter 231(R) for transmissive display is formed in the transmissive display region 51(R), and a color filter 232(R) for reflective display is formed in the reflective display region 52(R).

The liquid-crystal-layer thickness adjusting layer 25 is formed only in the reflective display region 52(R), not in the transmissive display region 51(R). Here, with the liquid-crystal-layer thickness adjusting layer 25, the thickness dR of the liquid crystal layer 8 in the reflective display region 52(R) is thinner than the thickness dT of the liquid crystal layer 8 in the transmissive display region 51(R). The thickness dR of the liquid crystal layer 8 in the reflective display region 52(R) is about half of the thickness dT of the liquid crystal layer 8 in the transmissive display region 51(R).

In the liquid crystal device 1b having such a configuration, like the first embodiment, the liquid crystal layer 8 includes liquid crystal having negative dielectric constant anisotropy, and vertical alignment films are used as the alignment films 13 and 26. For this reason, in the liquid crystal layer 8, the liquid crystal molecules are vertically aligned with respect to the surface of each of the substrates in a state in which a voltage is not applied. Further, the pixel electrode 12 is divided into three subpixel electrodes 121, 122, and 123 by slits 124 and 125 (notch), and one pixel 50(R) is divided into three subpixels 501, 502, and 503 in parallel along the extension direction of the data lines 6b. Among the three subpixel electrodes 121, 122, and 123, only the subpixel electrode 123 is electrically connected to the TFT 7b via the contact hole 151 in the interlayer insulating films 15b and 15c. The three subpixel electrodes 121, 122, and 123 are connected to one another via connecting portions 126 and 127 having narrow widths.

Here, the reflecting layer 22, the color filter 232(R) for reflective display, and the liquid-crystal-layer thickness adjusting layer 25 are formed in regions corresponding to the subpixels 501 and 503 at both ends (regions corresponding to the subpixel electrodes 121 and 123), excluding a region corresponding to the subpixel 502 at the center (a region corresponding to the subpixel electrode 122). Accordingly, in the present embodiment, in each pixel 50(R), the central region of the extension direction of the data lines 6b (Y direction) is the transmissive display region 51(R), and the regions at both ends of the extension direction of the data lines 6b are the reflective display regions 52(R). For this reason, the liquid-crystal-layer thickness adjusting layer 25 is formed in a boundary region of adjacent pixels in the extension direction of the data lines 6b, and is continuously formed in adjacent pixels in the extension direction of the data lines 6b. And then, an end of the liquid-crystal-layer thickness adjusting layer 25 constitutes a step portion 251 having a taper inclined upward in a boundary region of the reflective display region 52(R) and the transmissive display region 51(R) and, at the step portion 251, the liquid crystal molecules 81 have a pretilt with respect to the surface of each of the substrates. In the present embodiment, the step portion 251 is disposed to be separated from the boundary region between adjacent pixels in the extension direction of the data lines 6b. Besides, as shown in FIG. 10A, the step portion 251 of the liquid-crystal-layer thickness adjusting layer 25 is disposed inside the reflective display region 52(R).

In addition, at positions facing the centers of the three subpixel electrodes 121, 122, and 123 of the counter substrate 20, alignment control protrusions 191, 192, and 193 (alignment controllers), which protrude toward the element substrate 10, are formed below the alignment film 26. Accordingly, in the present embodiment, the alignment control protrusions 191, 192, and 193 are correspondingly formed in the three subpixels 501, 502, and 503. The alignment control protrusions 191, 192, and 193 are conical shapes each having the height of 1.2 μm and the diameter of a bottom surface of 12 μm, and constitute a gentle inclined surface having a pretilt in an interface of the alignment film 26. The alignment control protrusions 191, 192, and 193 can be formed by developing a novolac-based positive photoresist and post-baking. Moreover, as the alignment controllers, the alignment control slits (openings), which are described with reference to FIG. 6, may be used.

As described above, in the liquid crystal device 1b of the present embodiment, the liquid crystal molecules having negative dielectric constant anisotropy are vertically aligned with respect to the surface of each of the substrates, and are inclined by the application of a voltage, such that optical modulation is performed. For this reason, the liquid crystal device 1b is a transflective type, a degree of freedom of optical design is low, but a wide viewing angle can be obtained in transmissive display.

Further, in the liquid crystal device 1b of the present embodiment, the alignment control protrusions 191, 192, and 193 are formed in the transmissive display region 51 and the reflective display region 52 so as to control the alignment directions of the liquid crystal molecules. Therefore, in both the transmissive display region 51 and the reflective display region 52, the liquid crystal molecules are inclined in all directions. For this reason, in any one of the transmissive display region 51 and the reflective display region 52, the alignment irregularity does not occur, and thus disclination does not occur. In addition, with the liquid-crystal-layer thickness adjusting layer 25, the thickness of the liquid crystal layer 8 in the reflective display region 52 is thinner than that in the transmissive display region 51, such that the difference of retardation (Δn·d) between transmissive display light and reflective display light is eliminated. As a result, transmissive display light and reflective display light can be suitably optical-modulated.

In addition, in any pixel 50, the reflective display regions 52 are arranged at both ends of the extension direction of the data lines 6b (Y direction), and thus the liquid-crystal-layer thickness adjusting layer 25 is continuously formed between adjacent pixels in the extension direction of the data lines 6b. Therefore, an intensive traverse electric field is generated between adjacent pixels in the extension direction of the data lines 6b, the place where the traverse electric field is generated is separated from the place where the step portion 251 is formed. For this reason, little alignment irregularity occurs in the liquid crystal molecules. That is, though the liquid crystal molecules have the pretilt with respect to the surface of each of the substrates at the step portion 251, there is no case in which the liquid crystal molecules with the pretilt are significantly inclined by the traverse electric field at the time of the application of the off voltage. Besides, the place where the traverse electric field is generated is in the reflective display region 52 and, in the reflective display region 52, the liquid crystal layer 8 is thin, as compared with the transmissive display region 51, and thus an influence by the traverse electric field is not exerted. Further, in the reflective display region 52, there is little probability that incident light and reflected light pass through the places where the alignment irregularity occurs, and thus light is subjected to optical modulation by the liquid crystal layer 8 at the time of incidence or at the time of reflection. For this reason, according to the present embodiment, optical leakage in the off state due to the alignment irregularity in the vicinity of the boundary region between adjacent pixels in the extension direction of the data lines 6b can be prevented. As a result, contrast can be enhanced.

Further, in the present embodiment, among the three subpixel electrodes 121, 122, and 123, only the subpixel electrode 123 is electrically connected to the TFT 7b via the contact hole 151 of the interlayer insulating films 15c and 15d, and the contact hole 151 is formed at the position overlapping the subpixel electrode 123 in plan view, that is, within the reflective display region 52. Therefore, even when a concavo-convex due to the contact hole 51 occurs, since the thickness of the liquid crystal layer 8 in the reflective display region 52 is thin and there is little probability that both incident light and reflected light pass through the place where the alignment irregularity occurs, optical leakage in the off state due to the concavo-convex is difficult to generate, as compared with a case in which the contact hole 151 is formed in the transmissive display region 51. For this reason, in the present embodiment, high contrast can be obtained.

### Other Embodiments

Moreover, in the above-described embodiments, the pixels for color display correspond to red (R), green (G), and blue (B), but the pixels for color display may correspond to yellow, cyan, and magenta, in addition to red (R), green (G), and blue (B).

Electronic Apparatus

The liquid crystal device according to the invention can be used as a display unit of an electronic apparatus, such as a cellular phone, a notebook-type personal computer, a liquid crystal television, a view finder-type (or monitor-direct-view-type) video recorder, a digital camera, a car navigation device, a pager, an electronic organizer, an electronic calculator, a word processor, a workstation, a video phone, or the like.

The entire disclosure of Japanese Patent Application No. 2005-060024, filed Mar. 4, 2005, is expressly incorporated by reference herein.

What is claimed is:

1. A liquid crystal device comprising:
a first substrate;
a second-substrate that is disposed to face the first substrate;
a liquid crystal layer that is interposed between the first substrate and the second substrate, the liquid crystal layer including liquid crystal having negative dielectric constant anisotropy;
a plurality of first signal lines and a plurality of second signal lines that extend in directions intersecting each other; and
pixels that correspond to the intersections between first and second signal lines, each pixel including:
a pixel switching element;
a transmissive display region that emits light incident from the second substrate to the first substrate,
a reflective display region that reflects light incident from the first substrate,
an alignment controller that controls alignment directions of liquid crystal molecules in the liquid crystal layer, and
a liquid-crystal-layer thickness adjusting layer that results in the liquid crystal layer being thinner in each reflective display region than in the transmissive display region, the reflective display region of each pixel being located at least at both ends of the pixel with respect to an extension direction of the first signal lines.

2. The liquid crystal device according to claim 1,
wherein the plurality of pixels are driven in an inversion driving method in which signals having different polarities are applied to the liquid crystal layer between adjacent pixels in the extension direction of the first signal lines.

3. The liquid crystal device according to claim 1,
wherein the liquid-crystal-layer thickness adjusting layer includes tapered step portions in the vicinity of a boundary between adjacent reflective and transmissive display regions.

4. The liquid crystal device according to claim 3,
wherein the tapered step portions are located within the reflective display regions.

5. The liquid crystal device according to claim 1,
wherein the alignment controller includes a protrusion disposed between the liquid crystal layer and at least one of an inner surface of the first substrate and an inner surface of the second substrate.

6. The liquid crystal device according to claim 1,
wherein the alignment controller includes an opening formed in an electrode for driving liquid crystal, the electrode being disposed between the liquid crystal layer and at least one of an inner surface of the first substrate and an inner surface of the second substrate.

7. The liquid crystal device according to claim 1,
wherein each reflective display region includes a reflecting layer formed on the inner surface of the second substrate, and the transmissive display region includes a non-formation region of the reflecting layer.

8. The liquid crystal device according to claim 1,
wherein each pixel is divided into a plurality of island-shaped subpixels that correspond to the reflective and transmissive display regions, the subpixels being connected to one another via connecting portions having narrower widths than the subpixels, and
subpixels are arranged at least at both ends of each pixel in the extension direction of the first signal lines so as to correspond to the reflective display regions.

9. The liquid crystal device according to claim 8,
wherein a plurality of pixel electrodes are formed in between the liquid crystal layer and one of the first substrate and the second substrate, the pixel electrodes being electrically connected to the first signal lines via the pixel switching elements, the pixel switching elements being two-terminal-type nonlinear elements, the second signal lines being formed as stripe electrodes between the liquid crystal layer and the other one of the first substrate and the second substrate,
each pixel being defined by an opposing portion of each stripe electrode and each pixel electrode, and
at least one of the stripe electrode and the pixel electrode is a portion corresponding to each pixel, and is divided into a plurality of electrodes constituting the plurality of subpixels.

10. The liquid crystal device according to claim 8,
wherein a plurality of pixel electrodes are formed in between the liquid crystal layer and one of the first substrate and the second substrate, the pixel electrodes being electrically connected to the first signal lines via the pixel switching elements, the pixel switching elements being thin film transistors formed at the intersections of the first signal lines and the second signal lines, a common electrode being formed between the liquid crystal layer and the other one of the first substrate and the second substrate,
each pixel is defined by an opposing portion of the common electrode and each pixel electrode, and
one of the common electrode and each pixel electrode is a portion corresponding to each pixel, and is divided into a plurality of electrodes constituting the plurality of subpixels.

11. The liquid crystal device according to claim 9,
wherein an interlayer insulating film is formed between the pixel switching elements and the pixel electrodes, and the pixel electrodes and the pixel switching elements are electrically connected to each other via contact holes formed in the interlayer insulating film, and
the contact holes are correspondingly formed in the reflective display regions.

12. The liquid crystal device according to claim 1,
wherein the liquid-crystal-layer thickness adjusting layer has substantially the same thickness at a portion extending between reflective display regions of adjacent pixels.
